(19) United States
(12) Patent Application Publication
(10) Pub. No.: US 2016/0366894 A1
(43) Pub. Date: Dec. 22, 2016

(54) Method And System For The Production And Dispensing Of A Baking Mass

(71) Applicant: HAAS FOOD EQUIPMENT GMBH, Wien (AT)

(72) Inventors: JOHANNES HAAS, WIEN (AT); JOSEF HAAS, LEOBENDORF (AT); STEFAN JIRASCHEK, KOENIGSBRUNN (AT); FRANK WOUTERS, BEERSE (BE)

(21) Appl. No.: 15/122,339

(22) PCT Filed: Feb. 9, 2015
(86) PCT No.: PCT/EP2015/052618

§ 371 Date: Aug. 29, 2016

(30) Foreign Application Priority Data
Feb. 27, 2014 (AT) A136/2014

(51) Int. Cl. A21C 1/10; A21C 1/14; B01F 13/10; B01F 3/06; B01F 5/06; B01F 15/06; B01F 15/00; A21C 1/00; B01F 7/00

(52) U.S. Cl. CPC A21C 1/10; A21C 1/003; A21C 1/006; A21C 1/144; A21C 1/145; B01F 13/1027; B01F 7/00233; B01F 5/0602; B01F 15/066; B01F 15/00389; B01F 7/00641; A21C 1/1495; A21C 1/1455; A21C 1/1415; B01F 3/068; B01F 2013/1052; B01F 2215/0011; B01F 2015/061; B01F 2003/063

(57) ABSTRACT

A system for the continuous production and dispensing of a baking mass for the production of baked products such as, in particular, flat wafers, hollow wafers, wafer rolls, waffles or cakes includes a pre-mixing device for the mixing and/or storage of a first baking mass component and one or more pumps for the continuous conveyance of the first baking mass component from the pre-mixing device to a baking mass dispensing device. An after-mixing device is provided between the pre-mixing device and the baking mass dispensing device for the subsequent continuous addition of a powder such as, in particular, powder which tends to clump such as in particular flour, wheat flour, cereal flour, legume flour, powder having high water absorption, pre-gelatinized flour, pre-gelatinized starch and/or thickening agent. A method for the continuous production and dispensing of the baking mass is also provided.

The invention relates to a method and a system for the continuous production and dispensing of a baking mass, which is preferably flour-containing and which is suitable for producing baked products such as in particular flat wafers, hollow wafers, wafer rolls, waffles or cakes, wherein the system comprises the following components: a pre-mixing device for mixing and/or storing a first baking mass component and one or more pumps for the continuous conveyance of the first baking mass component from the pre-mixing device to a baking mass dispensing device.

Systems for mixing the components of a baking mass for wafers or cakes have been known for a fairly long time. For this purpose, a fixed mixing container is usually provided, in the interior of which a rotor is provided, which can be turned by means of a drive in order to mix baking mass components such as water, egg, flour, sugar and other ingredients which are introduced successively into the container. A homogeneous mass is thereby formed. This pre-mixed baking mass is subsequently conveyed into a container of the baking machine in order to be able to be introduced from there into baking moulds in a metered manner. In these known devices, the mixing of the baking masses does not take place continuously. Instead, a pre-determined quantity is pre-mixed and subsequently poured into a reservoir of the baking machine. A disadvantage of this device or these known arrangements is that the pre-mixed baking mass changes during the dwell time in the reservoir of the baking machine so that a variation in the product quality results over the consumption period of the reservoir.

It is now the object of the invention to provide a system for producing a baking mass which overcomes the disadvantages of the prior art and furthermore allows an efficient and flexible production of the baking mass, wherein at the same time the quality of the baking mass is improved. This object in particular also covers achieving the listed advantages of the invention.

The object according to the invention is solved in particular by the features of the independent claims.

The invention relates in particular to a system for the continuous production and dispensing of a baking mass for the production of baked products such as in particular flat wafers, hollow wafers, wafer rolls, waffles or cakes comprising: a pre-mixing device for the mixing and/or storage of a first baking mass component, one or more pump(s) for the continuous conveyance of the first baking mass component from the pre-mixing device to a baking mass dispensing device, wherein an after-mixing device is provided between the pre-mixing device and the baking mass dispensing device for the subsequent continuous addition of a powder, such as in particular powder which tends to clump such as in particular flour, wheat flour, cereal flour, legume flour, powder having high water absorption, pre-gelatinized flour, pre-gelatinized starch and/or thickening agent.

Optionally in all embodiments, powder of egg components and/or powder of milk components can be added continuously in the after-mixing device.

Optionally it is provided that the after-mixing device comprises a gassing device in which a gas or a gas mixture containing in particular air, oxygen, nitrogen and/or carbon dioxide is continuously added to the baking mixture and in particular to the first baking mass component.

Optionally it is provided that the after-mixing device comprises an oiling device in which oil is added continuously to the baking mass or the first baking mass component or that the after-mixing device comprises a liquid supply device in which a liquid comprising in particular oil, lecithins, water, salt, raising agent and/or soda is added continuously to the baking mass or the first baking mass component.

Optionally it is provided that the pre-mixing device contains the first baking mass component and that the first baking mass component substantially contains all the baking mass ingredients except for the ingredients supplied in the after-mixing device such as in particular flour and optionally air or oil.

Optionally it is provided that the after-mixing device contains a continuously operating powder conveying device by means of which the component of the continuously dispensed baking mass supplied in powder form, such as in particular the flour, is introduced.

Optionally it is provided that the powder conveying device is configured as a screw conveyor, the open outlet end of which opens into the after-mixing chamber.

Optionally it is provided that at least one moving mixing body configured as a rotor is provided in the after-mixing chamber, by means of which the powder is mixed with the first baking mass component and by means of which the powder is distributed substantially uniformly in the first baking mass component.

Optionally it is provided that a mixing body configured as a stator and fixed with respect to the surroundings or the after-mixing chamber is provided in the after-mixing chamber.

Optionally it is provided that a plurality of moving mixing bodies are provided, which mixing bodies are configured as mixing elements having an elongate or rod shape, which project substantially radially from a rotor shaft, that a drive is provided for rotation of the rotor shaft and the mixing elements provided thereon about the rotor axis of rotation and that the moving mixing bodies are provided in a first section of the after-mixing chamber.

Optionally it is provided that a plurality of fixed mixing bodies are provided, which mixing bodies are configured as mixing elements having an elongate or rod shape, which project substantially radially from the wall of the after-mixing chamber and protrude into the after-mixing chamber and that the fixed mixing bodies are provided in the first section of the after-mixing chamber.

Optionally it is provided that the after-mixing device comprises at least one vane mixing element which is provided rotatably in a second section of the after-mixing chamber.

Optionally it is provided that the vane mixing element is disposed movably and drivably at a normal distance from the vane principal axis on a circular orbit.

Optionally it is provided that the vane mixing element comprises an inclined vane surface and is disposed movably and drivably in the region of or near the wall of the second section of the after-mixing chamber on a circular orbit so that the baking mass components located in the after-mixing chamber are conveyed from the wall region into the middle of the after-mixing chamber.

Optionally it is provided that the powder conveying device opens through the wall of the second section into the wall region of the after-mixing chamber so that the powder, in particular the flour, is introduced in the second section into the after-mixing chamber.

Optionally it is provided that the vane mixing element is disposed pivotably about a pivot axis so that the inclined position of the vane surface is variable by means of a pivot drive.

Optionally it is provided that a plurality of vane mixing elements are provided.

Optionally it is provided that the second section of the after-mixing chamber is provided in the course of the flow of the first baking mass component upstream of the first section of the after-mixing chamber, so that the first baking mass component is initially moved through the second section and then through the first section and in particular is pumped.

Optionally it is provided that the rotor axis of rotation and the vane principal axis of rotation are arranged substantially coaxially.

Optionally it is provided that the after-mixing chamber and in particular the wall of the after-mixing chamber is or are configured in the form of a body of rotation and that the axis of symmetry of the wall configured in the form of a body of rotation is disposed substantially coaxially to the rotor axis of rotation and/or to the vane principal axis of rotation.

Optionally it is provided that the pressure in the after-mixing chamber is higher than the ambient pressure and that the screw conveyor opening into the after-mixing chamber is optionally under pressure so that an escape of the pressure of the after-mixing chamber through the screw conveyor is prevented and the powder can be introduced into the after-mixing chamber which is at positive pressure.

Optionally it is provided that the after-mixing device comprises a cooling system so that the after-mixing chamber and the first baking mass component located therein are cooled.

Optionally it is provided that a control unit is provided, by means of which the rotational speed and/or the torque of the drive of the flour supply device, the drive of the vane mixing elements, the drive of the moving mixing bodies and/or the drive of the main pump are controlled or regulated depending upon one another and/or depending upon the required baking mass volume of the baking machine.

The invention also relates to a method for the continuous production and dispensing of a baking mass for the production of baked products such as in particular flat wafers, hollow wafers, wafer rolls, waffles or cake comprising the following steps:
pre-mixing a first baking mass component in a pre-mixing device, wherein the first baking mass component substantially contains all the ingredients of the baking mass except for those components which are added to the first baking mass component in the after-mixing device;
conveying, in particular pumping the first baking mass component into and through an after-mixing device, wherein the conveying and in particular the pumping take place substantially continuously;
adding a fraction of the baking mass introduced in powder form into the first baking mass component flowing continuously through the after-mixing device, wherein the addition of the fraction introduced in powder form preferably takes place substantially continuously or continuously intermittently;
mixing and distributing the fraction introduced in powder form in the first baking mass component, wherein the mixing and distributing of the fraction introduced in powder form in the first baking mass component preferably takes place continuously whilst the first baking mass component is conveyed through the after-mixing device;
further conveying of the baking mass from the pre-mixing device to the baking mass dispensing device.

Optionally the method comprises the following step:
adding gas or a gas mixture containing in particular air, oxygen, nitrogen and/or carbon dioxide in a gassing device of the after-mixing device so that a foamy consistency is imparted to the baking mass component, wherein the addition of the gas or the gas mixture preferably takes place before the addition of the powdery fraction.

Optionally the method comprises the following step:
adding a liquid comprising in particular oil, lecithins, water, salt, raising agent and/or soda in a liquid supply device, wherein the addition of oil, lecithins and/or water preferably takes place after the addition of the powdery fraction.

Optionally the method comprises the following step:
adding oil in an oiling device of the after-mixing device.

Optionally the method comprises the following step:
adding water in the after-mixing device.

Optionally the method comprises the following step:

cooling the after-mixing chamber of the after-mixing device, in particular by pumping a cooling medium through cooling channels of the after-mixing device.

Optionally it is provided that during continuous conveyance through the after-mixing device, the first baking mass component is initially provided and mixed with a gas such as in particular air, then with a powder such as in particular flour and then with a liquid such as in particular oil in order to form the baking mass.

It was surprisingly found that due to the subsequent continuous addition of the flour component into a substantially flour-free pre-mixed first baking mass component, the quality of the baking mass can be improved appreciably. It was further surprisingly found that due to a subsequent addition of oil to a substantially oil-free pre-mixed first baking mass component, the baking mass quality can be further improved. This subsequent addition of flour and/or oil has proved particularly advantageous in baking masses which pass through a gassing device and are there provided with gas such as, for example, air. These in particular foamed and pressurized masses can be mixed with flour and optionally with oil by the device according to the invention in order to form the finished baking mass.

The subsequent addition of components of the baking mass supplied in powder form such as, for example, the subsequent addition of flour, starch powder such as maize starch or rice starch etc. as well as optionally cocoa powder, egg powder such as whole egg powder or yolk powder etc. has proved advantageous. The device according to the invention and the method according to the invention have a particularly advantageous effect in the addition of powders which tend to clump during conventional mixing with liquid baking mass components. Such powders which tend to clump are for example, flour, in particular wheat flour, cereal flour and/or legume flour, powder of egg components, powder of milk components, flour and/or powder having a high water absorption such as in particular pre-gelatinized flour, pre-gelatinized starch and thickener. These powders are supplied according to the invention in the after-mixing device and preferably mixed into a first baking mass component.

Also designated as powder in the sense of the invention are optionally also flour, starch powder, maize starch powder, rice starch powder, cocoa powder, egg powder, whole egg powder and/or egg yolk powder.

These components are added as powder—i.e. in powder form, to produce the baking mass. Optionally these powders are dissolved or swollen in the baking mass so that the powders in the baking mass are no longer in powder form. However, these components are added in powder form.

In particular, the following advantages can be achieved by the device according to the invention and the method according to the invention:

The baked product can be more easily removed from the baking mould. The finished bakery products have a very uniform structure and as a result have an improved consistency. The residual moisture of the baked products is improved. Furthermore, no gluten or almost no gluten is produced during production of the dough. Also any undesired formation of clumps, in particular clumping of flour or other powders can be prevented by the device and the method according to the invention. Also the energy which must be expended to mix the baking mass can be reduced in the method and the device according to the invention. The mixing of water and flour is reduced.

Furthermore, the baking mass can be produced continuously in an advantageous manner. In addition, by controlling the continuous process, a synchronization with the dispensing device of the baking machine can be accomplished. Thus, a corresponding quantity of fresh dough can be produced according to the dough dispensing in the baking machine.

Another advantage is that the powder, in particular the flour, is mixed into the baking mass at an adjustable pressure.

The efficiency of the emulsifiers is increased by the subsequent introduction of the flour or other powder.

The device according to the invention comprises a pre-mixing device. A first baking mass component is located in this pre-mixing device. This can be mixed in the pre-mixing device by pouring in the ingredients of the first baking mass component. Furthermore, a ready pre-mixed baking mass component can be poured into the pre-mixing device. Starting from this pre-mixing device, the first baking mass component is pumped to a baking mass dispensing device. The baking mass dispensing device is in particular connected to a baking machine or is configured as a dough pouring device. In the baking mass dispensing device, the finished baking mass is dispensed to form the bakery products.

A plurality of components are disposed between the baking mass dispensing device and the pre-mixing device. These components are, for example, and preferably connected to one another by pipelines. The baking mass can be conveyed through these pipelines.

Preferably one or a plurality of pumps are provided between the pre-mixing device and the baking mass dispensing device. These pumps are configured and/or suitable for conveying baking mass components, in particular to build up a pressure and/or to dispense the baking mass in the baking mass dispensing device.

According to the invention, an after-mixing device is provided between the pre-mixing device and the baking mass dispensing device. This after-mixing device is configured and/or suitable for continuously adding powder, in particular flour, to a mass flow of the first baking mass component. Furthermore, the powder, in particular the flour, can be mixed with the first baking mass component in the after-mixing device. In particular, the powder, in particular the flour, is continuously distributed uniformly in the first baking mass component. The after-mixing device can further be suitable and/or adapted for adding a liquid, in particular oil to the first baking mass component. Furthermore, in this case the after-mixing device is suitable for blending the oil with the first baking mass component and optionally also with the flour and mixing the ingredients uniformly with one another.

Optionally the after-mixing device comprises a gassing device. In this gassing device, baking mass components are blended with a gas, in particular with air, an N₂—CO₂—O₂ mixture, CO₂ or O₂. Preferably as a result the first baking mass component is given a foamy consistency. For example, the first baking mass component in the gassed state has a density of about 0.3 kg/l. However, other densities can be achieved, such as for example 0.3 kg/l, 0.4 kg/l, 0.5 kg/l, 0.6 kg/l, 0.7 kg/l, 0.9 kg/l or a density value which lies between the said density values.

The after-mixing device can be configured as a single mixing head or comprise a plurality of mixing heads or mixing devices. For example, the gassing device has its own driven device with its own mixing chamber which is distinct from the mixing chamber for the addition of powder, in particular flour or for the addition of liquid, in particular oil. For example, a mixing chamber can have a plurality of inlets for supplying different ingredients. For example, oil and flour can be supplied to a single mixing chamber. Preferably the openings for these two substances are provided in different sections of the mixing chamber.

Optionally, the after-mixing device comprises a cooling system. This cooling system can, for example, be formed by a heat exchanger. Preferably the after-mixing chamber is cooled. For example, the housing of the after-mixing device or the after-mixing chamber can be double-walled, wherein a cooling medium such as in particular cooling water can be guided through the cavity between the two walls of the housing. Optionally cooling channels can be provided in the housing or in the vicinity of the wall of the after-mixing chamber through which a cooling medium can be pumped. Optionally a single-circuit or a multi-circuit cooling system is provided.

The after-mixing device preferably comprises a powder conveying device. Powder, in particular flour, can be conveyed by this powder conveying device from a container into the after-mixing chamber. The powder conveying device is, for example, configured as a screw conveyor. The screw conveyor comprises a conveyor screw which is disposed in a tubular line. By turning the screw conveyor, powder, in particular flour, is conveyed in the direction of the after-mixing chamber. The screw conveyor preferably opens through the wall of the after-mixing chamber into the after-mixing chamber.

Preferably the powder conveying device is configured in such a manner that the positive pressure which optionally prevails in the after-mixing chamber cannot escape through the screw conveyor. To this end, the after-mixing chamber is preferably completely filled with powder in the region of the opening into the after-mixing chamber so that the intermediate spaces between the conveyor screw and the tubular body are completely filled with powder, in particular with flour. As a result, the powder itself acts as a closure for the screw conveyor. By conveying further, the powder, in particular the flour, is introduced into the after-mixing chamber against the pressure of the after-mixing chamber.

The after-mixing chamber preferably comprises at least one moving mixing body which in particular is designated as a rotor. This moving mixing body can be moved to mix the baking mass components introduced into the after-mixing chamber. For example, the mixing body is configured as a mixing element projecting from a rotating and driven shaft. Preferably a plurality of mixing bodies are provided.

Optionally a fixed mixing body is provided. This can also be designated as a stator. Optionally the fixed mixing body is configured as a mixing element projecting inwards from the wall of the after-mixing chamber which is connected in a fixed position or fixedly to the wall of the after-mixing chamber. By turning and moving the moving mixing body with respect to the fixed mixing body, an improvement in the mixing effect is achieved. Preferably a plurality of fixed mixing bodies are provided. Preferably a plurality of moving mixing bodies are provided.

Optionally further mixing bodies are provided. For example, a vane mixing element can be provided. This vane mixing element has a vane surface. The vane surface is preferably inclined so that through movement of the vane mixing element, baking mass components can be conveyed from the outer region of the after-mixing chamber into the inner region. For example, the vane mixing element is movable about a shaft and in particular on a circular orbit. In this case, the vane mixing element is preferably disposed outside in the region of the wall and moved in the immediate vicinity to this wall. As a result, the vane mixing element acts as a scraper which is suitable and/or adapted to scrape off or scratch off baking mass components from the wall of the after-mixing chamber and preferably convey them inwards. Preferably a plurality of vane mixing elements are provided. Optionally these vane mixing elements can be inclined or pivoted so that the inclination of the vane surface is variable. As a result, the mixing effect can be varied.

Optionally the powder conveying device opens into that region of the wall of the mixing chamber in which the vane mixing elements are moved. As a result, the emerging powder, in particular the flour, is grasped by the vane mixing elements and conveyed into the inner region of the mixing chamber. This further prevents the powder from being deposited on the wall of the after-mixing chamber and for example, forming clumps.

The different mixing elements of the after-mixing device can optionally be disposed in a plurality of sections of the after-mixing chamber. For example, the after-mixing device comprises a first section in which a pair of moving and fixed mixing bodies is disposed.

Optionally the after-mixing device comprises a second section of the after-mixing chamber in which the vane mixing element or elements are provided.

Optionally the screw conveyor for supplying the powder opens into the second section. Optionally the supply for the liquid such as oil opens into the first section.

In all the embodiments the after-mixing device is configured as a continuously operating after-mixing device. In this, a further mass component is added continuously to a mass flow of a first baking mass component. The addition is made during flow of the first baking mass component. In particular, in the device according to the invention, gas, powder and liquid, in particular air, flour and/or oil are added to the first baking mass component. As a result of this arrangement, during pouring of dough in the baking machine, the first baking mass component is in contact with further components such as air, gas and/or oil for the same duration during each individual pouring. As a result, one of the advantageous inventive effects is achieved.

According to a preferred embodiment, the after-mixing device comprises an after-mixing chamber. This after-mixing chamber is preferably cylindrical, configured in the form of a body of rotation or rotationally symmetrical. The axes of rotation of the mixing bodies preferably run along the axis of symmetry of the rotationally symmetrical form. Thus, the vane mixing elements and also the moving mixing elements can be rotated about axes of rotation which are disposed coaxially with the axis of symmetry of the rotationally symmetrical after-mixing chamber. Preferably the second section of the after-mixing chamber is configured as a chamber in the form of a body of rotation so that the vane mixing elements can be moved on a circular orbit in the region of the wall of the after-mixing chamber. The vane mixing elements can thus act as scrapers.

Preferably first the second section and then the first section of the after-mixing chamber are disposed along the axis of symmetry of the after-mixing chamber configured in the form of a body of rotation. As a result, the first baking mass component entering into the after-mixing chamber is firstly conveyed through the second section and then through the first section. The first baking mass component is, for example, conveyed along the axis of symmetry. The powder is supplied, for example, radially or tangentially through the wall in the form of a body of rotation. In particular, the powder is supplied in the second section of the after-mixing chamber. The liquid is supplied, for example, through the wall of the after-mixing chamber in the form of a body of rotation, in the radial or tangential direction. Preferably the liquid, in particular the oil, is supplied in the first section of the after-mixing chamber.

The system according to the invention comprises a plurality of pumps and mixing heads. These elements are preferably driven by drives, particularly preferably by rotational drives. Optionally the speeds or the torque of the individual drives can be controlled and/or regulated. For example, the throughput of the pumps, in particular the main pump, can be regulated or controlled so that the total throughput of the system can be adapted to the required baking mass flow of the baking machine. This control and/or regulation can take place, for example, depending on the throughput of the dough pouring or a pump of the baking machine. Optionally a pressure regulation is provided which regulates or controls the throughput and the conveying capacity of the main pump depending on the pressure in the baking mass dispensing device. Depending on the throughput or also independently of this parameter, the speeds or the torque of the mixing device, in particular the after-mixing device or its components can be controlled and/or regulated. This relates in particular to the drive of the rotor shaft.

The conveying capacity or the mass flow of the supplied powder, in particular the flour, can be controlled or regulated depending on the total throughput. For example, the speed or the torque of the drive of the conveyor screw of the screw conveyor can be regulated so that during continuous production of the baking mass, the desired or the same powder fraction is always contained in the baking mass even with different throughput. The supply of further baking mass components such as, for example, air or oil can also be controlled or regulated so that the mass flow of these baking mass components can be varied depending on the total mass flow.

Optionally the viscosity of the finished baking mass can be regulated. To this end, the viscosity of the finished baking mass, for example, in the baking mass dispensing device, is measured and subsequently used directly or indirectly as a control variable. Water can be added to the after-mixing chamber to regulate the viscosity. To this end, the after-mixing device has a device for supplying water. This device can be provided in all embodiments and can be designed similarly to the oiling device. As a result of the supply of water to the first baking mass component in the after-mixing device, the viscosity of the finished baking mass can be reduced. For example, the conveying capacity of the pump for conveying the water is the control variable for regulating the viscosity. The addition of water is preferably also made in the continuously conveyed first baking mass component.

In the system according to the invention or the method according to the invention, a first baking mass component is formed in the pre-mixing device. This first baking mass component can also be formed continuously. No storage tank is required for the continuously produced first baking mass component. The pre-mixer preferably mixes the supplied ingredients of the first baking mass component continuously. However it is consistent with the inventive idea that a certain quantity of a pre-mixed first baking mass component is stored intermediately in a storage tank.

The device according to the invention can in particular also have the following features:

The rotor shaft can have a cooling system. In this case a cooling medium can be passed through the shaft configured as a hollow shaft in order to cooling the after-mixing chamber from inside. The housing of the after-mixing chamber can also be cooled. Preferably the cooling capacity is controlled or regulated so that the temperature in the interior of the after-mixing chamber or also for example in the baking mass dispensing device can be controlled and/or regulated. This, for example, comprises a temperature control section.

The vane mixing elements are preferably mounted at an inclination on a disk, wherein the angle and also the position of the vane mixing elements are optionally variable. The vane mixing elements can also be mounted exchangeably so that different vane mixing elements can be used for different baking masses. The vane mixing elements are in particular configured in such a manner that thin layers of the powder conveying into the after-mixing chamber, in particular of the flour, are pre-distributed or distributed uniformly in the after-mixing chamber. This distribution is accomplished prior to conveying the baking mass components through the first section of the after-mixing chamber. Complete thorough mixing of the baking mass components takes place in the first section of the after-mixing chamber. This thorough mixing is accomplished in particular by moving mixing bodies and optionally also by fixed mixing bodies. The vane mixing elements are turned about a vane principal axis of rotation. This rotation is accomplished by a drive. The speed of the vane mixing elements about the vane principal axis of rotation can, for example, be between 100 and 3000 revolutions per minute. The desired speed can be adjusted by control and/or regulation of the drive. The moving mixing bodies are rotated about the rotor shaft or the rotor axis of rotation at a speed of for example, 50 to 400 revolutions per minute. Optionally the speed of the vane mixing elements is higher than the speed of the rotor shaft.

The number of fixed mixing bodies and/or moving mixing bodies can be varied. Thus individual mixing elements or mixing bodies can be removed. The mixing result is thereby influenced.

The powder conveying device in particular comprises a screw conveyor. The screw conveyor can, for example, be weight-regulated. Optionally the powder, in particular the flour, is compressed or pressurized in the powder conveying device. For this purpose, the screw of the screw conveyor for example has a varying or variable geometry over the longitudinal extension of the conveyor screw, or a variable pitch. In particular, the powder is compressed in the region of the outlet of the screw conveyor so that the pressure of the after-mixing chamber cannot escape through the screw conveyor. The optionally compressed powder thereby forms a compact block which is conveyed continuously or in a clocked manner in the direction of the after-mixing chamber. On entry into the after-mixing chamber, the compressed powder is entrained and distributed by the vane mixing elements. In particular, parts of the compact powder block are cut off or scraped off by the vane mixing elements and distributed in the after-mixing chamber. In this case, the powder is added continuously to the mass flow of the first baking component.

In addition, a closure can be provided which mechanically closes the outlet opening of the screw conveyor when the conveying of the screw conveyor is stopped. This also prevents the pressure of the after-mixing chamber being able to escape through the screw conveyor.

The device according to the invention is in particular suitable and/or adapted to add powder, optionally liquid and/or a gas mixture such as air to the first baking mass component which has a certain positive pressure.

The first baking mass component is preferably a pumpable mass, for example, liquid or viscous.

The contents or ingredients of the baking mass for the product mooncake are for example:

| No. | Ingredients |
|---|---|
| 1 | Sorbitol |
| 2 | Aromatic GL24 |
| 3 | Potassium sorbate |
| 4 | Sodium bicarbonate |
| 5 | SAPP |
| 6 | Salt |
| 7 | Chocolate flavouring |
| 8 | Water |
| 9 | Glucose syrup DE 60 |
| 10 | Whole egg, liquid |
| 11 | Emulsifier, pasty |
| 12 | Granulated sugar |
| 13 | Enzyme Actifresh PY16, powder |
| 14 | Vanilla |
| 15 | Egg white powder |
| 16 | Emulsifier, powder |
| 17 | Alkalized cocoa powder |
| 18 | Skimmed milk powder |
| 19 | Wheat starch |
| 20 | Wheat flour |
| 21 | Vegetable oil |

The first baking mass component in all embodiments preferably comprises all the ingredients of the baking as except for those ingredients which are added in the after-mixing device and in particular are added continuously. Preferably flour is added in the after-mixing device. According to a preferred embodiment, flour and oil are added in the after-mixing device. Optionally a portion of those ingredients which are added in the after-mixing device are already contained in the first baking mass component. In this case, only the remainder of the required quantity of these components or this component are added in the after-mixing device.

The device according to the invention is used in particular for executing the method according to the invention which comprises the following steps, for example, for producing the product mooncake:
mixing ingredients 1-19 of the above table of ingredients, thus forming the first baking mass component,
conveying the first baking mass component to the after-mixing device
continuously adding and mixing the first baking mass component with the ingredients gas, flour and oil
further conveying the baking mass to the dispensing device.

The method for producing the baking mass for the product “mooncake” can also in particular comprise the following steps:
pre-mixing the first baking mass component in the pre-mixing device
conveying the first baking mass component to and/or into the after-mixing device
continuously pumping the first baking mass component through the after-mixing chamber which is preferably completely filled with the baking mass components
optionally gassing the first baking mass component in the gassing device so that the first baking mass component acquires a foamy consistency
conveying the first baking mass component having an optionally foamy consistency into the after-mixing chamber, in particular into the second section of the after-mixing chamber
supplying the flour component via the flour supply device
optionally pre-compressing the flour in the flour supply device so that the flour is conveyed substantially in the form of a compact block in the direction of the after-mixing chamber
moving the vane mixing elements so that parts of the optionally compressed flour are separated or scraped off
distributing or pre-distributing the flour in the after-mixing chamber
further conveying the first baking mass component having an optionally foamy consistency and pre-mixed flour component in the first section of the after-mixing chamber
moving the mixing bodies
further mixing the first baking mass component having an optionally foamy consistency and the flour component
supplying oil through the oiling device in a first section of the after-mixing chamber
final mixing of the baking mass by moving the mixing bodies
emergence of the baking mass from the after-mixing device
conveying the baking mass to the baking mass dispensing device.

The contents or ingredients of the baking mass for the product flat wafers having a crispy brittle consistency are, for example:

| Raw material | Recipe |
|---|---|
| Water, about | 74 |
| Salt | 0.3 |
| Sodium bicarbonate | 0.2 |
| Wheat flour | 50 |
| Oil/fat | 0.75 |
| Lecithin, liquid | 0.25 |

wherein the first baking mass component contains water, salt and sodium bicarbonate and the flour is added in the after-mixing device.

The device according to the invention is used in particular for executing the method according to the invention which comprises the following steps, for example, for producing the product flat wafers:
mixing the ingredients salt, water and sodium bicarbonate, thus forming the first baking mass component,
conveying the first baking mass component to the after-mixing device
continuously adding and mixing the first baking mass component with flour
continuously supplying oil and lecithin and
further conveying the baking mass to the dispensing device.

The method according to the invention for producing the product wafers can, for example, comprise the following steps:
pre-mixing water, salt and sodium bicarbonate in the pre-mixing device, thus forming the first baking mass component
conveying the first baking mass component to and/or into the after-mixing device, in particular into the second section of the after-mixing chamber
continuously pumping the first baking mass component through the after-mixing chamber which is preferably completely filled with the baking mass components
supplying the flour into the after-mixing chamber, in particular into the second section of the after-mixing chamber
optionally pre-compressing the flour so that a substantially compact block is formed
moving the vane mixing elements so that parts of the optionally compressed flour are separated or scraped off
distributing the flour in the second section of the after-mixing chamber
further conveying the first baking mass component and the flour in the first section of the after-mixing chamber
moving the mixing bodies for finish thorough mixing of the baking mass
continuously supplying oil and lecithin
optionally adding water in the or in the first section of the after-mixing chamber to influence the viscosity of the baking mass
further conveying the baking mass from the after-mixing chamber and from the after-mixing device to the dispensing device
measuring the viscosity

Subsequently baking masses are listed which can be produced in the system according to the invention:

Poured sugar ice cream cone with 15% sugar

| Raw material | kg |
|---|---|
| Water, about | 56 |
| Sugar | 6.25 |
| Caramelized sugar | 0.4 |
| Sunette | 0.1 |
| Salt | 0.15 |
| Sodium bicarbonate | 0.08 |
| Starch | 1.6 |
| Wheat flour | 40 |
| Oil/fat | 2 |
| Lecithin, liquid | 0.4 |
| Vanilla | 0.01 |

The first baking mass component which is preferably pre-mixed for example comprises the following ingredients: water, sugar, caramelized sugar, Sunette, salt, sodium bicarbonate, starch and vanilla.

In the after-mixing device the following ingredients for example are added continuously: wheat flour, oil/fat and lecithin (liquid)

Basic Recipe for Fresh Egg Wafers

| Raw material | kg |
|---|---|
| Water, hot about | 35 |
| Whole egg | 125 |
| Sugar | 105 |
| Sorbitol (solution) | 15 |
| Salt | 1 |
| Ammonium bicarbonate | 1.5 |
| Skimmed milk powder | 2 |
| Powder lecithin | 1 |
| Flavourings, about | 0.5 |
| Wheat flour | 100 |
| Fat, liquid | 80 |
| Glycerine | 10 |
| Wafer breaking paste | 30 |
| Sweet lupine flour | 10 |
| Preservative, about | 0.5 |
| | 516.5 |

The first baking mass component which is preferably pre-mixed for example comprises the following ingredients: water (hot), whole egg, sugar, sorbitol (solution), salt, ammonium bicarbonate, skimmed milk powder, powder lecithin, flavourings, glycerine, wafer breaking paste, preservatives and sweet lupine flour.

In the after-mixing device, the following ingredients for example are added continuously: wheat flour, fat (liquid).

Recipe for Hollow Wafer Sheets

| Raw material | Recipe H1 |
|---|---|
| Water, about | 75 |
| Salt | 0.3 |
| Sodium bicarbonate | 0.2 |
| Caramelized sugar | 0.5 |
| Milk powder | 0.5 |
| Starch | 4 |
| Wheat flour | 50 |
| Oil/fat | 0.5 |
| Lecithin, liquid | 0.5 |

The first baking mass component which is preferably pre-mixed for example comprises the following ingredients: water, salt, sodium bicarbonate, caramelized sugar, milk powder and starch.

In the after-mixing device, for example the following ingredients are added continuously: wheat flour, oil/fat and lecithin (liquid).

Pillow-Shaped Wafer Sticks

| Raw material | Quantity, kg |
|---|---|
| Water, about (a) | 26 |
| Sugar, crystal (b) | 15 |
| Fructose, powder (c) | 2 |
| Milk powder | 1 |
| Egg powder | 0.4 |
| Powder lecithin (d) | 0.2 |
| Vanilla flavour | 0.05 |
| Wheat flour (e) | 20 |
| Fat (f) | 0.3 |
| Lecithin, liquid | 0.1 |
| Total: | 65.05 |

The first baking mass component, which is preferably pre-mixed for example comprises the following ingredients: water, sugar (granulated), fructose (powder), milk powder, egg powder, powder lecithin and vanilla flavouring.

In the after-mixing device, the following ingredients for example are added continuously: wheat flour, fat and lecithin (liquid).

Recipe for Wafer Sticks

| Raw material | Quantity, kg |
|---|---|
| Water, about | 26 |
| Sugar | 15 |
| Milk powder | 1 |
| Egg powder | 0.5 |
| Flavouring | 0.05 |
| Wheat flour | 20 |
| Fat/oil | 0.4 |
| Lecithin | 0.1 |

The first baking mass component which is preferably pre-mixed for example comprises the following ingredients: water, sugar, milk powder, egg powder and flavouring.

In the after-mixing device, for example, the following ingredients are added continuously: wheat flour, fat/oil and lecithin.

In all the methods according to the invention, in particular the first baking mass component is conveyed continuously by a main pump through the system and/or through the after-mixing device. In this case, in the after-mixing device the first baking mass component firstly optionally passes through a gassing device, then the after-mixing chamber wherein in the after-mixing chamber the first baking mass component initially passes through a second section and then a first section.

The first baking mass component principally comprises liquid components. For this reason the first baking mass component is substantially liquid. As a result of the liquid consistency the ingredients of the first baking mass component can be mixed more simply and more efficiently. The viscosity of the baking masses is only increased by adding the powder, in particular the flour, whereby a liquid to viscous but nevertheless pumpable mass is formed. As a result, the efficiency of the method is increased. The first baking mass component of all the baking masses is preferably solid-free, powder-free and in particular flour-free. Another advantage of the continuous method is that optionally no storage tank is required. This on the one hand affords the advantage of a simpler structure of the machine. On the other hand, a uniform quality of the baking mass is achieved during the baking process.

By regulating the throughput of the system according to the invention, the throughput of the system can be adapted according to the baking mass consumption of the baking machine. This prevents the dough from needing to be returned or eliminated from the production process when the baking mass consumption is lower. The efficiency of the system and the method is thereby further improved.

Preferably the system has a plurality of mixing chambers which are interconnected by pipelines. The pipelines preferably have a considerably smaller diameter than the mixing chambers. One mixing chamber can, for example, be the pre-mixing chamber. One mixing chamber can for example be the mixing chamber for supplying the gas in the gassing device. Another mixing chamber is, for example, the after-mixing chamber wherein this preferably contains two sections. Optionally however the two sections of the after-mixing chamber are also individual mixing chambers which are interconnected via a pipeline.

Preferably all the mixing chambers of the after-mixing device are completely filled with the baking mass component(s). This means that the baking mass components flow completely through the mixing chambers. As a result, the continuously operating system according to the invention differs from conventional mixers in which only a rotor blends baking mass components in a fixed open container. In particular the after-mixing chamber is completely filled with or has flowing through it the first baking mass component and those baking mass components which are added in the after-mixing device. A more efficient, thorough mixing is possible as a result of this arrangement.

The invention is described further hereinafter with reference to the figures.

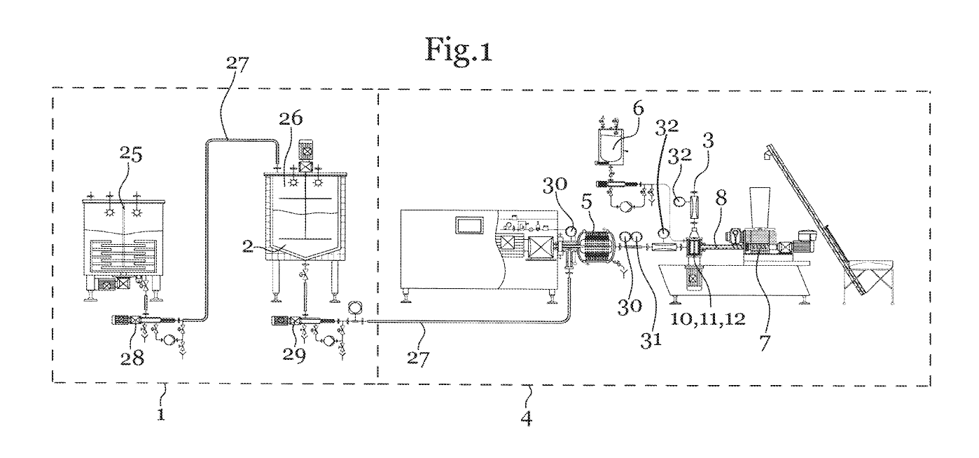

FIG. 1 shows a first embodiment of a system according to the invention in a schematic side or sectional view.

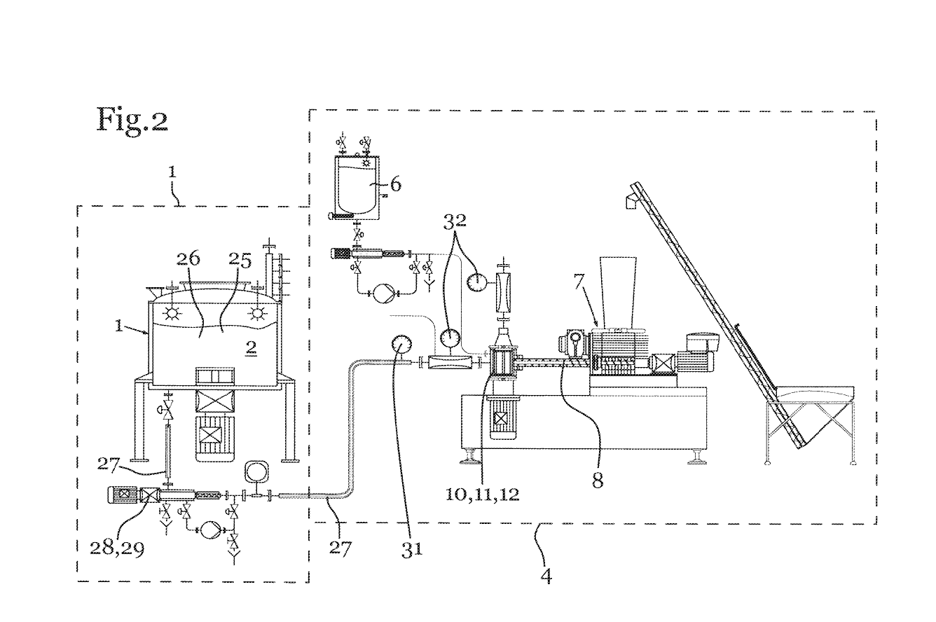

FIG. 2 shows another embodiment of a system according to the invention in a schematic side or sectional view.

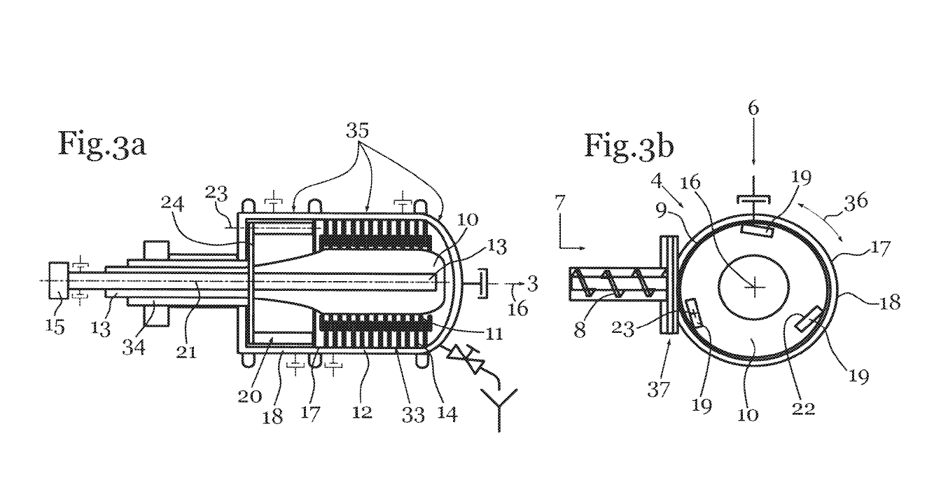

FIGS. 3a and 3b show two schematic sectional views of a possible configuration of an after-mixing device.

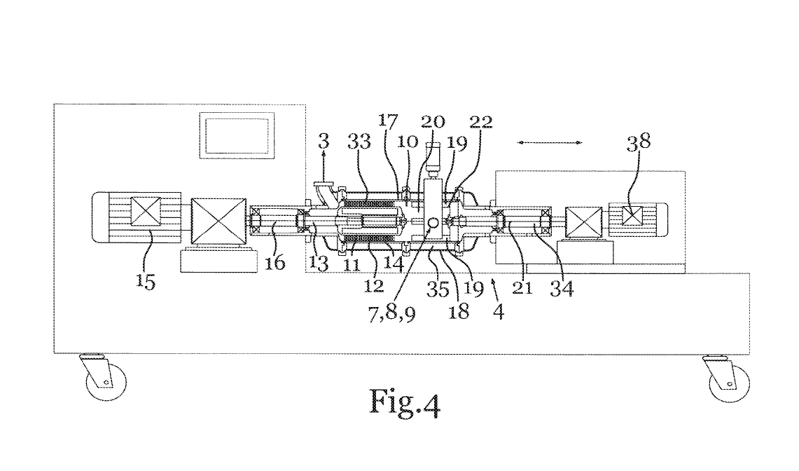

FIG. 4 shows another embodiment of a possible after-mixing device in a schematic sectional view.

FIG. 1 shows a system according to the invention in a schematic side view. The system comprises a pre-mixing device 1. This pre-mixing device 1 comprises a pre-mixer 25 and a storage tank 26. In the pre-mixer 25 the ingredients to be mixed are blended to form a first baking mass component. The first baking mass component 2 is stored in the storage tank 26. Optionally the pre-mixer 25 and the storage tank 26 are configured as a single module of the system according to the invention. In the present embodiment of FIG. 1 the two components pre-mixer 25 and storage tank 26 are interconnected via a pipeline 27. In order to convey the baking mass component through the pipeline 27, a pre-mixing pump 28 is provided. In the present embodiment the pre-mixer pump 28 is provided downstream of the pre-mixer 25 in the flow direction of the baking mass component.

The main pump 29 is provided downstream of the storage tank 26 and optionally downstream of the pre-mixing device 1 in the flow direction of the first baking mass component. This conveys the first baking mass component 2 from the pre-mixing device 1 to the further components. Pipelines 27 are again provided for conveying the first baking mass component 2. Through these the first baking mass component is pumped from the pre-mixing device 1 to the after-mixing device 4. In the present embodiment, the after-mixing device 4 comprises a gassing device 5. This comprises a mixing head and a gas supply. In the mixing head the gas is distributed substantially uniformly in the first baking mass component 2. In so doing, gas bubbles of a desired size are formed, which give the first baking mass component 2 a foamy consistency in the conveying direction downstream of the gassing device 5.

In the present embodiment the after-mixing device comprises an oiling device 6. Oil is added to the first baking mass component by this oiling device 6. Preferably a mixing device is provided by means of which the first baking mass component 2 is blended with oil.

In the present embodiment a powder-conveying device 7 is provided. This conveys powder, in particular flour into the after-mixing device and in particular into the mixing head thereof so that flour is added to the first baking mass component. The mixing head comprises an after-mixing chamber 10 as well as mixing bodies 11 and 12. Preferably the powder conveying device 7 comprises a screw conveyor 8 via which the flour is conveyed in to the after-mixing chamber 10 of the after-mixing device 4.

The system further comprises a baking mass dispensing device 3 in which the ready-mixed baking mass can be dispensed from the system. For example, this baking mass dispensing device 3 is connected to a baking machine or the dough supply of a baking machine.

In the present embodiment the first baking mass component 2 is passed from the pre-mixing device 1 into the after-mixing device 4. After the after-mixing device 4, the finished baking mass is conveyed through the baking mass dispensing device 3 from the system. In the after-mixing device 4 in the present embodiment the first baking mass component is firstly gassed. As a result, it acquires a foamy structure. Then in the present embodiment, the gassed first baking mass component is blended with flour. The gassed first baking mass component which is already blended with flour is blended with oil. Optionally other baking mass components are added. On emerging from the baking mass dispensing device, substantially the finished baking mass is formed.

The present arrangement of FIG. 1 is in particular suitable for producing cake baking masses. For example, products having the product names “layer cake” or “mooncake” can be formed from this.

The system further optionally comprises temperature measuring device 30, pressure measuring devices 31 and/or pressure regulators 32. The moving parts of the after-mixing device 4 are preferably driven by means of one or more drives. Thus, for example the gassing device comprises a drive which can drive a rotor of the mixing head in order to mix the gas with the first baking mass component and produce a foamy consistency. Furthermore, the oiling device and/or the after-mixing device comprise one or more further drives. The oiling device 6 further comprises another pump which pumps the oil into the mixing chamber.

During the gassing, the first baking mass component is provided with a gas so that this acquires a foamy consistency. As a result of the supply of gas, the pressure in this region is increased. In particular, the pressure in the after-mixing chamber 10 is thereby increased. This also means that the flour and optionally the oil must be supplied at elevated pressure. Consequently the oil must be pressurized, for example, in order to be able to supply it to the mixing chamber.

The same applies to the flour. Preferably for this purpose the powder conveying device 7 is configured as a screw conveyor 8. The screw conveyor 8 is completely closed or filled with flour in the region of the opening into the after-mixing chamber 10. This prevents any escape of pressure through the screw conveyor 8. An advantage of this configuration is that the flour can be poured at ambient pressure into the powder conveying device 7. The pressure is only built up in the screw conveyor 8 which is automatically sealed by the flour. The structure of the system is thereby appreciably simplified.

FIG. 2 shows another embodiment of a system according to the invention. This embodiment is, for example, suitable for producing baking masses for products such as wafers. The baking masses are usually poured onto open baking tongs in baking tong ovens and then baked in closed baking tongs in a circulating manner. The system comprises a storage tank 26 and optionally a pre-mixer 25. In the present embodiment these two components are configured as a single device. The pre-mixing device 1 is adapted and/or suitable for mixing or for storing a first baking mass component 2. From there the first baking mass component 2 is passed via pipelines 27, driven by a pre-mixer pump 28 or a main pump 29 to the after-mixing device 4. The after-mixing device 4 comprises a powder conveying device 7. This adds flour to the first baking mass component 2 in the after-mixing chamber 10 of the after-mixing device 4. The powder conveying device 7 comprises a screw conveyor 8. This screw conveyor opens into the after-mixing chamber 10. Mixing bodies 11, 12 are provided in the after-mixing chamber 10. These are used to blend flour with the first baking mass component 2. The system according to FIG. 2 further comprises an oiling device 6. This conveys oil coming from a tank into the after-mixing chamber 10. There the first baking mass component 2 is blended with oil.

The system again further comprises temperature measuring devices 30, pressure measuring devices 31 and/or pressure regulators 32.

FIGS. 3a and 3b show details of the after-mixing device 4 in respectively one schematic sectional view. The plane of intersection of FIG. 3a runs substantially along the rotor axis of rotation of the rotor shaft. The plane of intersection of FIG. 3b runs substantially normally to the rotor axis of rotation.

FIG. 3a shows a part of a pre-mixing device comprising an after-mixing chamber 10. The after-mixing chamber 10 is suitable and/or adapted for adding further baking mass components to the first baking mass component 2 and mixing the first baking mass component 2 with further baking mass components.

The after-mixing device 4 comprises a plurality of moving mixing bodies 11. The rotor of the after-mixing chamber 10 is formed by the moving mixing bodies 11. To this end the moving mixing bodies 11 project from the rotor shaft 13. Preferably the moving mixing bodies 11 project substantially in the radial direction from the rotor shaft 13 outwards into the after-mixing chamber 10. The rotor shaft 13 can be turned about a rotor axis of rotation 16. This turning is driven rotationally by a drive 15. The moving mixing body or bodies 11 comprise or are mixing elements 14. These mixing elements 14 are configured to be substantially elongate or rod-shaped.

In the present embodiment fixed mixing bodies 12 are provided in the after-mixing chamber 10. These act substantially as a stator of the after-mixing chamber 10. The fixed mixing bodies 12 are connected substantially rigidly or fixedly to the inner wall 17 of the after-mixing chamber 10. Since these fixed mixing bodies 12 are disposed substantially in a fixed position, this results in a relative movement during movement of the moving mixing bodies 11. This results in a mixing of the baking mass components introduced into the after-mixing chamber 10.

The mixing elements 14 of the moving mixing bodies are arranged in a star shape projecting substantially radially outwards. A plurality of groups of mixing elements 14 arranged in a star shape can be provided consecutively along the course of the rotor shaft 13.

The mixing elements 14 of the fixed mixing bodies are arranged in a star shape projecting substantially radially outwards. A plurality of groups of mixing elements 14 arranged in a star shape can be provided consecutively along the course of the rotor shaft 13.

In the present embodiment, the fixed and moving mixing bodies 11, 12 are provided in a first section 33 of the after-mixing chamber 10.

The after-mixing device 4 of the present embodiment comprises a vane mixing element 19. Preferably a plurality of, in particular three vane mixing elements 19 are provided. The vane mixing elements are disposed along a circular orbit rotatably about a vane principal axis of rotation 21. Preferably a drive is provided to turn the vane mixing elements 19 about the vane principal axis of rotation 21. In the present embodiment, the vane principal axis of rotation 21 is disposed concentrically to the rotor axis of rotation 16. The vane mixing elements 19 and the moving mixing bodies 11 can be driven by a single drive or by separate drives. In the case of separate drives the vane mixing elements 19 can be moved independently by the mixing bodies 11.

In the present embodiment the drive shaft of the vane mixing elements 34 is disposed concentrically to the rotor shaft 13. Optionally one of the two shafts is designed as a hollow shaft through the cavity of which the other shaft can be guided.

Preferably the after-mixing chamber 10 has a cooling system 35. In this case, the housing 18 of the after-mixing chamber 10 is provided with a coolant channel through which coolant can be guided. In the present embodiment the housing 18 is double-walled wherein a coolant can be guided through between the two walls.

In the present embodiment the after-mixing device 10 comprises a second section 20. The vane mixing elements 19 are provided in this second section 20. Preferably the second section 20 is provided next to the first section 33 of the after-mixing chamber. Preferably the first baking mass component coming from the pre-mixing device 1 is passed firstly through the second section of the after-mixing chamber 20 and then through the first section of the after-mixing chamber 33. Preferably the supply line of the oiling device opens into the first section of the after-mixing chamber. Preferably the outlet of the screw conveyor 8 for supplying flour opens into the second section 33 of the after-mixing chamber 10.

FIG. 3b shows a sectional view of parts of an after-mixing device 4 according to the invention. In particular the sectional plane runs through the second section 20 of the after-mixing chamber 10. The vane mixing elements 19 are provided in this second section 20. The vane mixing elements 19 each have a vane surface 22. This vane surface/these vane surfaces is or are inclined. In particular the vane surface 22 deviates from the tangential direction. The tangential direction is that direction which lies at a tangent to that circular orbit on which the vane mixing elements 19 are moved. In particular, the vane surfaces 22 are inclined in such a manner that baking mass components from the outer region of the after-mixing chamber 10, in particular from the wall 17 of the after-mixing chamber are moved into the interior, i.e. in the direction of the rotor axis of rotation 16.

The vane mixing elements 19 are moved in the direction of rotation 36 during operation. The after-mixing device 4 further comprises a powder conveying device 7. This powder conveying device 7 comprises a screw conveyor 8. The screw conveyor 8 or its outlet end 9 opens into the after-mixing chamber 10. Preferably the outlet end 9 of the screw conveyor 8 opens through the wall 17 of the after-mixing chamber 10 into the after-mixing chamber 10. Particularly preferably the screw conveyor 8 opens into the second section of the after-mixing chamber. Optionally the screw conveyor 8 opens in the course of the cylindrical wall of the after-mixing chamber into the after-mixing chamber so that the vane mixing elements 19 can be moved past the outlet end 9 in order to convey emerging flour from the outer region into the inner region of the after-mixing chamber.

Preferably the after-mixing device 4 comprises an oiling device 6. This guides oil into the mixing chamber. Particularly preferably the oiling device 6 opens into the after-mixing chamber in the first section 33 of the after-mixing chamber.

According to a preferred embodiment, the vane mixing elements 19 can be pivoted. To this end the vane mixing elements 19 each have a pivot axis 23. In the diagram in FIG. 3b this pivot axis 23 runs in a substantially projecting manner. Through the pivoting of the vane mixing elements 19 the inclination of the vane surface 22 can be varied. As a result, the mixing intensity can also be adapted. If the vanes are set more steeply, the baking mass components are conveyed at a steeper angle towards the middle. A pivoting drive 24 is provided for pivoting the vane mixing elements.

Optionally the after-mixing device 4 comprises a closure 37. This closure 37 is suitable and/or adapted to stop the supply of flour and/or to close the opening or the outlet end of the screw conveyor.

The vane mixing elements 19 are in particular designed as scrapers. These scrape along the after-mixing chamber in the vicinity of the wall 17 in order to convey baking mass components from this region into the centre of the after-mixing chamber. In particular during the supply of flour it is advantageous if the flour is conveyed from the wall region into the centre. As a result, clumping can be further reduced. Furthermore, due to the geometrical arrangement of the opening of the screw conveyor and the vane mixing elements 19, a better distribution of the incoming flour in the after-mixing device 4 is achieved. The flour enters into the after-mixing chamber 10 substantially in the radial direction to the vane principal axis of rotation 21.

The ready-mixed baking mass or the baking mass components mixed in the mixing chamber exit substantially along the axes of rotation, i.e. axially in FIG. 3a.

However, the mixed baking mass components can also exit in the direction of the baking mass dispensing device 3 also radially, tangentially or in another direction.

FIG. 4 shows a schematic sectional view of another possible embodiment of parts of the after-mixing device 4. Unlike the embodiment in FIG. 3, the two mixing devices of the after-mixing chamber 10 are driven from two different sides. The functions of the individual elements correspond to the functions of the elements from FIG. 3a. The after-mixing device 4 comprises an oiling device 6, a powder conveying device 7, a screw conveyor 8, an outlet end 9 of the screw conveyor 8 and an after-mixing chamber 10. The after-mixing chamber 10 is divided into a first section 33 and a second section 20. Vane mixing elements 19 are provided in the second section 20. These vane mixing elements 19 can be moved along a circular orbit about a vane principal axis of rotation 21. The vane mixing elements each have a vane surface 22 which is inclined in such a manner that baking mass components are conveyed from the region of the wall 17 of the after-mixing chamber 10 towards the centre of the after-mixing chamber 10. Optionally the vane mixing elements 19 are configured to be pivotable. The pivotability can be accomplished, for example, about a pivot axis 23. The pivotability can be accomplished by means of a pivoting drive 24. However, the pivoting can also be accomplished manually where the respective inclination can be fixed by a fixing screw or a similar means. Thus, the inclination can be varied according to the baking mass to be produced.

The after-mixing device 4 further comprises a cooling system 35. The vane mixing elements 19 are driven by means of a drive shaft 34 or a drive 38 located on the right in the diagram.

The ready-mixed baking mass components are guided towards the baking mass dispensing device 3 in the embodiment shown.

In all embodiments another powder can also be added instead of or in addition to flour.

In all embodiments another liquid can also be added instead of or in addition to oil.

### REFERENCE LIST

1 Pre-mixing device
2 First baking mass component
3 Baking mass dispensing device
4 After-mixing device
5 Gassing device
6 Oiling device
7 Powder conveying device
8 Screw conveyor
9 Outlet end of screw conveyor
10 After-mixing chamber
11 Moving mixing body
12 Fixed mixing body
13 Rotor shaft
14 Mixing element
15 Drive for turning the rotor shaft
16 Rotor axis of rotation
17 Wall of after-mixing chamber
18 Housing of after-mixing chamber
19 Vane mixing element
20 Second section of after-mixing chamber
21 Vane principal axis of rotation
22 Vane surface
23 Pivot axis
24 Pivot drive
25 Pre-mixer
26 Storage tank
27 Pipeline
28 Pre-mixer pump
29 Main pump
30 Temperature measuring device
31 Pressure measuring device
32 Pressure regulator
33 First section of after-mixing chamber
34 Drive shaft of vane mixing elements
35 Cooling system
36 Direction of rotation
37 Closure
38 Drive for rotation of vane mixing elements

1-29. (canceled)

30. A system for continuously producing and dispensing a baking mass for producing baked products, the system comprising:
a pre-mixing device for at least one of mixing or storing a first baking mass component;
a baking mass dispensing device;
at least one pump for continuously conveying the first baking mass component from said pre-mixing device to said baking mass dispensing device; and
an after-mixing device disposed between said pre-mixing device and said baking mass dispensing device for subsequently continuously adding a powder.

31. The system according to claim 30, wherein:
the baked products are flat wafers, hollow wafers, wafer rolls, waffles or cakes; and
the powder is a powder which tends to clump and is at least one of flour, wheat flour, cereal flour, legume flour, powder having high water absorption, pre-gelatinized flour, pre-gelatinized starch or thickening agent.

32. The system according to claim 30, wherein said after-mixing device includes a gassing device for continuously adding a gas or a gas mixture to the baking mixture.

33. The system according to claim 32, wherein the gas or gas mixture contains at least one of air, oxygen, nitrogen or carbon dioxide, and said gassing device adds the gas or gas mixture to the first baking mass component.

34. The system according to claim 30, wherein:
said after-mixing device includes an oiling device in which oil is added continuously to the baking mass or the first baking mass component; or
said after-mixing device includes a liquid supply device in which a liquid is added continuously to the baking mass or the first baking mass component.

35. The system according to claim 34, wherein the liquid includes at least one of oil, lecithins, water, salt, raising agent or soda.

36. The system according to claim 30, wherein said pre-mixing device contains the first baking mass component and the first baking mass component substantially contains all ingredients of the baking mass except for ingredients supplied in said after-mixing device.

37. The system according to claim 36, wherein the ingredients supplied in said after-mixing device are flour and optionally air or oil.

38. The system according to claim 30, wherein said after-mixing device contains a continuously operating powder conveying device for introducing the component of the continuously dispensed baking mass supplied in powder form.

39. The system according to claim 38, wherein the component supplied in powder form is flour.

40. The system according to claim 38, which further comprises an after-mixing chamber, said powder conveying device having a screw conveyor with an open outlet end opening into said after-mixing chamber.

41. The system according to claim 40, which further comprises at least one moving mixing body configured as a rotor and disposed in said after-mixing chamber for mixing the powder with the first baking mass component and for distributing the powder substantially uniformly in the first baking mass component.

42. The system according to claim 41, which further comprises a mixing body disposed in said after-mixing chamber, configured as a stator and fixed relative to surroundings or to said after-mixing chamber.

43. The system according to claim 30, which further comprises:
an after-mixing chamber having a first section;
a rotor shaft disposed in said after-mixing chamber and defining a rotor axis of rotation;
a plurality of moving mixing bodies configured as mixing elements having an elongate or rod shape and projecting substantially radially from said rotor shaft;
a drive for rotation of said rotor shaft and said mixing elements provided thereon about said rotor axis of rotation; and
moving mixing bodies disposed in said first section of said after-mixing chamber.

44. The system according to claim 43, wherein:
said after-mixing chamber has a wall;
a plurality of fixed mixing bodies configured as mixing elements have an elongate or rod shape, project substantially radially from said wall of said after-mixing chamber and protrude into said after-mixing chamber; and
said fixed mixing bodies are provided in said first section of said after-mixing chamber.

45. The system according to claim 44, wherein said after-mixing chamber has a second section, and said after-mixing device includes at least one vane mixing element disposed rotatably in said second section of said after-mixing chamber.

46. The system according to claim 45, wherein said at least one vane mixing element defines a vane principal axis, and said at least one vane mixing element is movable and drivable at a distance from said vane principal axis on a circular orbit.

47. The system according to claim 45, wherein said at least one vane mixing element has an inclined vane surface and is movable and drivable in a region of said wall in said second section of said after-mixing chamber on a circular orbit, causing the baking mass components located in said after-mixing chamber to be conveyed from said wall region into a middle of said after-mixing chamber.

48. The system according to claim 47, wherein said powder conveying device opens through said wall in said second section into said wall region of said after-mixing chamber for introducing the powder or flour in said second section into said after-mixing chamber.

49. The system according to claim 47, wherein said at least one vane mixing element is disposed pivotably about a pivot axis, and a pivot drive varies an inclined position of said vane surface.

50. The system according to claim 45, wherein said at least one vane mixing element is a plurality of vane mixing elements.

51. The system according to claim 45, wherein said second section of said after-mixing chamber is disposed upstream of said first section of said after-mixing chamber along a course of a flow of the first baking mass component, causing the first baking mass component to be initially moved or pumped through said second section and then through said first section.

52. The system according to claim 46, wherein said rotor axis of rotation and said vane principal axis of rotation are disposed substantially coaxially.

53. The system according to claim 46, wherein said after-mixing chamber or said wall of said after-mixing chamber is configured as a body of rotation, and said wall configured as a body of rotation has an axis of symmetry disposed substantially coaxially to at least one of said rotor axis of rotation or to said vane principal axis of rotation.

54. The system according to claim 40, wherein:
said after-mixing chamber has a pressure being higher than an ambient pressure;
said screw conveyor of said powder conveying device is completely filled with powder in a vicinity of said opening into said after-mixing chamber and is optionally under pressure for preventing an escape of the pressure of said after-mixing chamber through said screw conveyor and for permitting said screw conveyor of said powder conveying device to introduce powder into said after-mixing chamber; and
said after-mixing chamber is at a positive pressure for receiving the powder.

55. The system according to claim 40, wherein said after-mixing device includes a cooling system for cooling said after-mixing chamber and the first baking mass component located therein.

56. The system according to claim 45, wherein:
said powder conveying device is a flour supply device having a drive;
said at least one pump is a main pump having a drive;
said at least one vane mixing element is a plurality of vane mixing elements having a drive; and
a control unit controls or regulates at least one of a rotational speed or a torque of said drive of said flour supply device, said drive of said vane mixing elements, said drive of said moving mixing bodies or said drive of said main pump depending upon at least one of one another or upon a required baking mass volume of the system.

57. A method for continuously producing and dispensing a baking mass for producing baked products, the method comprising the following steps:
providing a pre-mixing device and an after-mixing device;
pre-mixing a first baking mass component in the pre-mixing device, the first baking mass component substantially containing all ingredients of the baking mass except for components being added to the first baking mass component in the after-mixing device;
substantially continuously conveying the first baking mass component into and through the after-mixing device;
adding a fraction of the baking mass in powder form into the first baking mass component flowing continuously through the after-mixing device;
mixing and distributing the fraction introduced in powder form into the first baking mass component and
further conveying the baking mass from the pre-mixing device to a baking mass dispensing device.

58. The method according to claim 57, wherein:
the baked products are flat wafers, hollow wafers, wafer rolls, waffles or cake;
the step of substantially continuously conveying the first baking mass component is carried out by pumping;
the step of adding the fraction of the baking mass in powder form takes place substantially continuously or continuously intermittently; and
the step of mixing and distributing the fraction introduced in powder form in the first baking mass component takes place continuously while the first baking mass component is conveyed through the after-mixing device.

59. The method according to claim 58, which further comprises adding a gas or a gas mixture in a gassing device of the after-mixing device to impart a foamy consistency to the baking mass component.

60. The method according to claim 59, wherein the gas or the gas mixture contains at least one of air, oxygen, nitrogen or carbon dioxide, and the addition of the gas or the gas mixture takes place before the addition of the powdery fraction.

61. The method according to claim 57, which further comprises adding a liquid in a liquid supply device.

62. The method according to claim 61, wherein the liquid is at least one of oil, lecithins, water, salt, raising agent or soda, and the liquid is added after the addition of the powdery fraction.

63. The method according to claim 57, which further comprises adding oil in an oiling device of the after-mixing device.

64. The method according to claim 57, which further comprises adding water in the after-mixing device.

65. The method according to claim 57, which further comprises cooling an after-mixing chamber of the after-mixing device.

66. The method according to claim 65, which further comprises carrying out the cooling step by pumping a cooling medium through cooling channels of the after-mixing device.

67. The method according to claim 57, which further comprises during the continuous conveyance through the after-mixing device, initially providing and mixing the first baking mass component with a gas, then with a powder and then with a liquid in order to form the baking mass.

68. The method according to claim 67, wherein the gas is air, the powder is flour and the liquid is oil.
